(19) United States
(12) Patent Application Publication
(10) Pub. No.: US 2025/0278217 A1
(43) Pub. Date: Sep. 4, 2025

(54) PRINTING SYSTEM CAPABLE OF SAVING PRINT JOB IN CLOUD STORAGE OTHER THAN STORAGE OF CLOUD PRINT SERVER IN CLOUD PRINT SERVICE, CONTROL METHOD FOR PRINTING SYSTEM, INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: Kei Tominaga, Ibaraki (JP)

(21) Appl. No.: 19/062,118

(22) Filed: Feb. 25, 2025

(30) Foreign Application Priority Data
Feb. 29, 2024 (JP) 2024-029949

(51) Int. Cl. G06F 3/12

(52) U.S. Cl. CPC G06F 3/1204; G06F 3/1267; G06F 3/1287

(57) ABSTRACT

A mechanism capable of saving a print job in a cloud storage other than a storage of a cloud print server in a cloud print service is provided. A printing system providing a cloud print service includes at least one processor, and a memory coupled to the processor storing instructions that, when executed by the processor, cause the processor to perform causing an information processing apparatus, which has received an instruction from a user, to generate a print job and transmit the print job to a set save location, and causing an image forming apparatus, which has received a print execution instruction from the user, to obtain the print job saved in the save location and execute a print processing of the obtained print job. The save location is a cloud storage other than a storage of a cloud print server managed by a manufacturer of the image forming apparatus.

### BACKGROUND OF THE INVENTION

### Field of the Invention

The present invention relates to a printing system, a control method for the printing system, an information processing apparatus, a control method for the information processing apparatus, and a storage medium.

### Description of the Related Art

A printing system has been known that provides a cloud print service in which a print job is transmitted from a client terminal, which is an information processing apparatus, to an image forming apparatus via an external cloud server (see Japanese Laid-Open Patent Publication (kokai) No. 2023-85933). In such a printing system, the client terminal obtains document data from a storage location designated by a user, generates a print job based on the obtained document data, and transmits the print job to the image forming apparatus via a cloud print server. Conventionally, in cloud printing, a print job generated by a client terminal

is saved in a predetermined save location, specifically, in a storage of a cloud print server managed by a printer manufacturer, and then transmitted to an image forming apparatus. For this reason, conventionally, it is not possible to save the print job in a save location other than the storage of the cloud print server, for example, in a cloud storage that is being used by the user.

### SUMMARY OF THE INVENTION

The present invention provides a mechanism capable of saving a print job in a cloud storage other than a storage of a cloud print server in a cloud print service.

Accordingly, the present invention provides a printing system that

provides a cloud print service, the printing system comprising at least one processor, and a memory coupled to the processor storing instructions that, when executed by the processor, cause the processor to perform causing an information processing apparatus, which has received a print job transmission instruction from a user, to generate a print job and transmit the print job to a save location that has been set, and causing an image forming apparatus, which has received a print execution instruction from the user, to obtain the print job that has been saved in the save location and execute a print processing of the obtained print job. The save location is a cloud storage other than a storage of a cloud print server managed by a manufacturer of the image forming apparatus.

Accordingly, the present invention provides an information processing apparatus that causes an image forming apparatus, which supports a cloud print service, to execute a print processing, the information processing apparatus comprising at least one processor, and a memory coupled to the processor storing instructions that, when executed by the processor, cause the processor to perform receiving an instruction from a user, and a control of generating a print job in accordance with the instruction and transmitting the print job to a save location that has been set. The image forming apparatus obtains the print job that has been saved in the save location in accordance with a print execution instruction received from the user, and executes a print processing of the obtained print job. The save location is a cloud storage other than a storage of a cloud print server managed by a manufacturer of the image forming apparatus.

According to the present invention, it is possible to save the print job in the cloud storage other than the storage of the cloud print server in the cloud print service.

Further features of the present invention will become apparent from the following description of exemplary embodiments with reference to the attached drawings.

### BRIEF DESCRIPTION OF THE DRAWINGS

FIG. 1 is a configuration diagram that shows an example of a printing

system according to a first embodiment.

FIG. 2 is a block diagram that schematically shows a hardware configuration of a client terminal shown in FIG. 1.

FIG. 3 is a block diagram that schematically shows a hardware configuration of an image forming apparatus shown in FIG. 1.

FIG. 4A and FIG. 4B are sequence diagrams that show the steps of a first cloud print processing executed by the printing system shown in FIG. 1.

FIG. 5 is a diagram that shows an example of a setting screen displayed on an output unit shown in FIG. 2.

FIG. 6 is a diagram that shows an example of a print setting screen displayed on the output unit shown in FIG. 2.

FIG. 7 is a diagram that shows an example of a cloud print authentication screen displayed on an operation unit shown in FIG. 3.

FIG. 8 is a configuration diagram that shows an example of a printing system according to a second embodiment.

FIG. 9A and FIG. 9B are sequence diagrams that show the steps of a second cloud print processing executed by the printing system shown in FIG. 8.

FIG. 10 is a diagram that shows an example of a cloud storage authentication screen displayed on the operation unit shown in FIG. 3.

FIG. 11 is a configuration diagram that shows an example of a printing system according to a third embodiment.

FIG. 12 is a sequence diagram that shows an example of an account linking registration processing executed by the printing system shown in FIG. 11.

FIG. 13A and FIG. 13B are sequence diagrams that show the steps of a third cloud print processing executed by the printing system shown in FIG. 11.

### DESCRIPTION OF THE EMBODIMENTS

The present invention will now be described in detail below with reference to the accompanying drawings showing embodiments thereof.

Hereinafter, preferred embodiments of the present invention will be described in detail with reference to the drawings. Here, before describing the configuration of a printing system according to each of the preferred embodiments, the features of the printing system according to each of the preferred embodiments will be described. In the printing system according to each of the preferred embodiments, first, an administrator registers an image forming apparatus in a tenant of a cloud print server. The tenant is a service system deployed on the cloud. Next, the administrator performs settings regarding which users belonging to the tenant are permitted to use the image forming apparatus. A user who has been permitted to use the image forming apparatus submits a print job including document data and a print setting to the cloud print server from a client terminal. The cloud print server saves the received print job in a cloud storage. The image forming apparatus obtains the print job that has been saved in the cloud storage, and executes a print processing of the obtained print job.

First, a printing system according to a first embodiment of the present invention will be described.

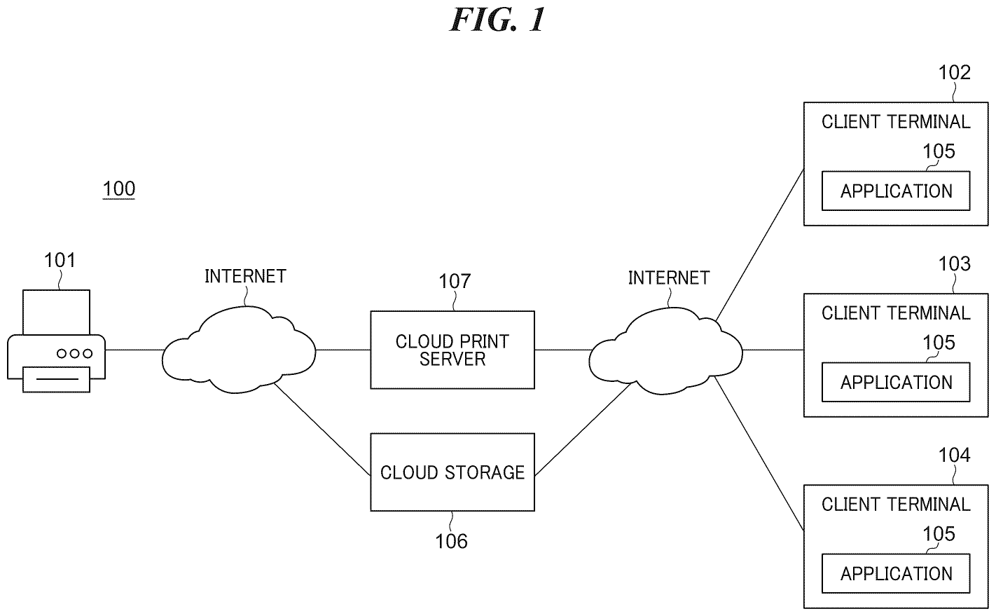

FIG. 1 is a configuration diagram that shows an example of a printing system 100 according to the first embodiment.

As shown in FIG. 1, the printing system 100 includes an image forming apparatus 101, a cloud storage 106, a cloud print server 107, and one or more client terminals that are information processing apparatuses. It should be noted that in the first embodiment, as an example, a configuration in which the printing system 100 includes three client terminals 102 to 104 will be described. In addition, in the first embodiment, a configuration in which the printing system 100 includes one cloud storage 106 will be described as an example, but the present invention is not limited to this configuration. For example, the printing system 100 may be configured to include a plurality of cloud storages. The image forming apparatus 101, the cloud print server 107, and the client terminals 102 to 104 are each communicably connected to each other via the Internet.

The image forming apparatus 101 is an image forming apparatus that supports a cloud print service, and has been registered in the tenant of the cloud print server 107. The image forming apparatus 101 obtains a print job from the cloud print server 107, and executes a print processing of the obtained print job.

The client terminals 102 to 104 each submit a print job to the cloud print server 107. Each of the client terminals 102 to 104 includes an application 105 capable of saving, editing, and issuing a print instruction for document data.

The application 105 is, for example, an Internet browser or Adobe Acrobat. In addition, the application 105 is Google Workspace from Google LLC or Microsoft's Office application, which can access and edit document data in the cloud storage 106. For example, in the client terminal 102, in accordance with a print instruction received from a user, the application 105 performs a print job generation processing that generates a print job from document data and a print job transmission processing that transmits the print job. These processing are realized by a print framework incorporated in an operating system (an OS) of the client terminal 102. In the case that the client terminal 102 generates a print job, a printer driver constituting the print framework is used to perform assignment of a print setting and converting document data into a print job.

It should be noted that in the first embodiment, a configuration in which the client terminals 102 to 104 each include the application 105 with the same functions and configuration will be described, but the present invention is not limited to this configuration. For example, the client terminals 102 to 104 may each include a different application, as long as the application is capable of issuing a print instruction. The user is able to use the print framework from the application 105 to perform the print job generation processing and the print job transmission processing.

The cloud storage 106 is an online storage service, and provides a service for managing document data and the like online. The cloud storage 106 is, for example, Google Drive from Google LLC or OneDrive from Microsoft.

The cloud print server 107 is a server managed by the printer manufacturer, and manages print jobs in the cloud print service. For example, the cloud print server 107 is able to save print job related information including a storage location, an access token, etc. of a print job saved in the cloud storage 106 from the client terminal 102 or the like in accordance with an instruction from the user. In addition, the cloud print server 107 is able to transmit the print job related information to the image forming apparatus 101 in response to a request received from the image forming apparatus 101.

Next, the hardware configurations of the client terminals 102 to 104 and the cloud print server 107 will be described. It should be noted that in the first embodiment, the client terminals 102 to 104 and the cloud print server 107 have the same hardware configuration, and the hardware configuration of the client terminal 102 will be described below as an example.

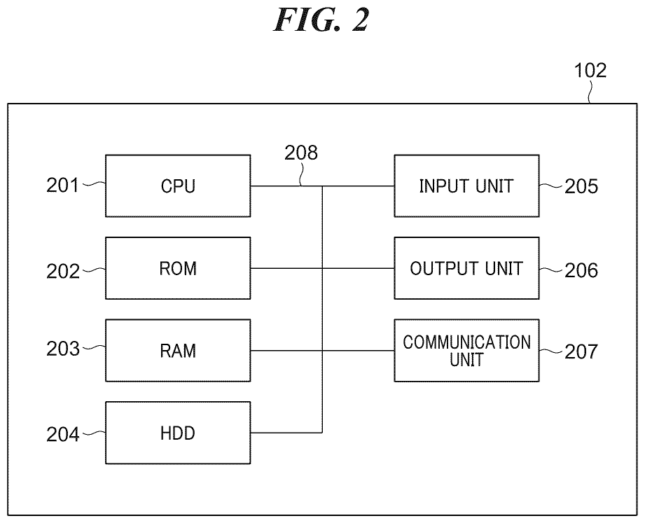

FIG. 2 is a block diagram that schematically shows the hardware configuration of the client terminal 102 shown in FIG. 1. As shown in FIG. 2, the client terminal 102 includes a central processing unit (a CPU) 201, a read only memory (a ROM) 202, a random-access memory (a RAM) 203, a hard disk drive (an HDD) 204, an input unit 205, an output unit 206, and a communication unit 207. The CPU 201, the ROM 202, the RAM 203, the HDD 204, the input unit 205, the output unit 206, and the communication unit 207 are connected to each other via a bus 208.

The CPU 201 directly or indirectly controls the respective devices connected via the bus 208, and executes programs for implementing the present invention. The ROM 202 stores a basic input/output system (a BIOS) and the like. The RAM 203 is used as a working area for the CPU 201, and is also used as a primary storage area for loading software modules for implementing the present invention. The HDD 204 stores the OS, which is the basic software, and various kinds of software modules. It should be noted that in the first embodiment, the client terminal 102 may be configured to include a storage device such as a solid state drive (an SSD) that has the same functions as an HDD, instead of an HDD. The input unit 205 includes a keyboard, a pointing device, and the like. The output unit 206 is, for example, a display that displays various kinds of information. The communication unit 207 is an interface for connecting to a network.

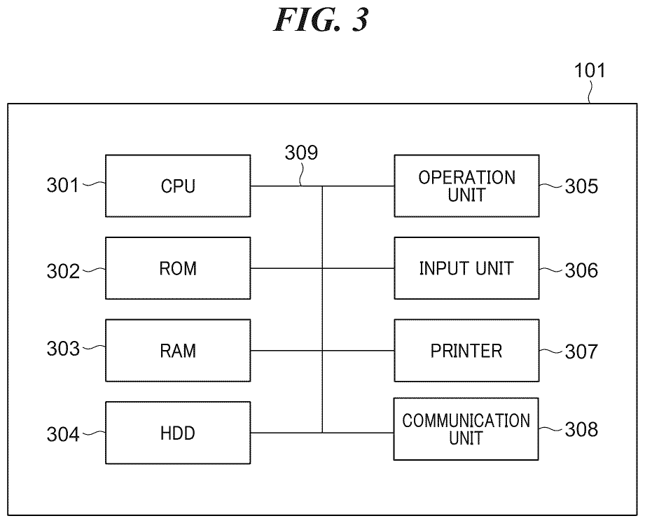

FIG. 3 is a block diagram that schematically shows a hardware configuration of the image forming apparatus 101 shown in FIG. 1. As shown in

FIG. 3, the image forming apparatus 101 includes a CPU 301, a ROM 302, a RAM 303, an HDD 304, an operation unit 305, an input unit 306, a printer 307, and a communication unit 308. The CPU 301, the ROM 302, the RAM 303, the HDD 304, the operation unit 305, the input unit 306, the printer 307, and the communication unit 308 are connected to each other via a bus 309.

The CPU 301 directly or indirectly controls the respective devices connected via the bus 309, and executes programs for implementing the present invention. The ROM 302 stores a BIOS and the like. The RAM 303 is used as a working area for the CPU 301, and is also used as a primary storage area for loading software modules for implementing the present invention. The HDD 304 stores an OS, which is the basic software, and various kinds of software modules. It should be noted that in the first embodiment, the image forming apparatus 101 may be configured to include an SSD or the like that has the same functions as an HDD, instead of an HDD. The operation unit 305 is a display that is capable of being operated by touch. The input unit 306 includes a numeric keypad, an IC card reader, and the like. The printer 307 is a printer engine that executes a print processing of a print job received from the outside via the communication unit 308. The communication unit 308 is a network interface for connecting to the Internet or an office LAN.

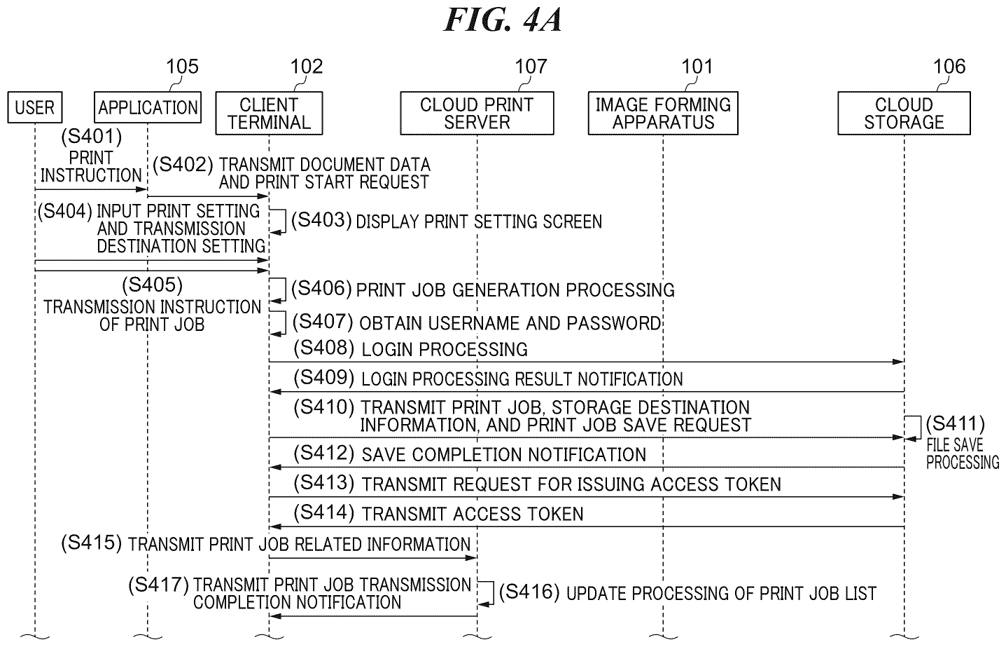

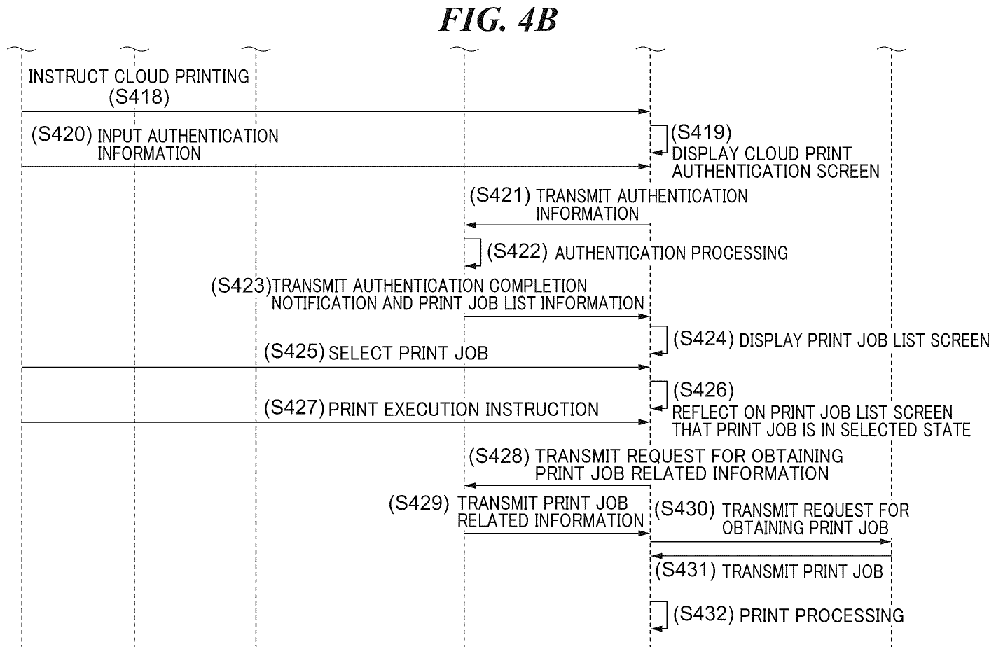

FIG. 4A and FIG. 4B are sequence diagrams that show the steps of a first cloud print processing executed by the printing system 100 shown in FIG. 1. In FIG. 4A and FIG. 4B, as an example, a configuration in which the first cloud print processing is performed by the client terminal 102, the cloud print server 107, the cloud storage 106, and the image forming apparatus 101 will be described. In FIG. 4A and FIG. 4B, the processing by the client terminal 102 is realized by the CPU 201 loading a program stored in the ROM 202 or the like into the RAM 203 and executing the program. The processing by the cloud print server 107 is realized by a CPU of the cloud print server 107 loading a program stored in a ROM or the like of the cloud print server 107 into a RAM of the cloud print server 107 and executing the program. The processing by the image forming apparatus 101 is realized by the CPU 301 loading a program stored in the ROM 302 or the like into the RAM 303 and executing the program.

It should be noted that in FIG. 4A and FIG. 4B, it is assumed that in the client terminal 102, authentication information for the cloud storage 106 and authentication information for the cloud print server 107 have been outputted from the application 105 to the print framework. The authentication information for the cloud storage 106 is authentication information used when logging in to the cloud storage 106, and is, for example, a username and a password. The authentication information for the cloud print server 107 is authentication information used when logging in to the cloud print server 107, and is, for example, a username and a password. When the print framework logs in with the authentication information, the print framework is able to perform transmitting a print job to the cloud storage 106 and transmitting print job related information to the cloud print server 107. In addition, the application 105 is able to download document data saved in the cloud storage 106, and edit or view document data saved in the local environment or the cloud storage 106. The application 105 is also able to save the print job in the cloud storage 106 from the print framework.

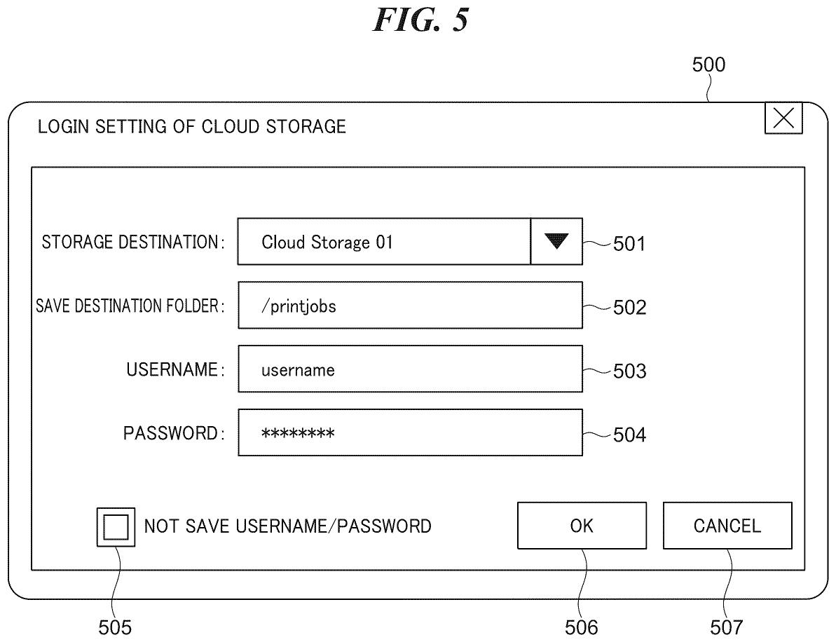

It should be noted that in the first embodiment, it is assumed that the authentication information for the cloud storage 106 has been set in advance by the user on a setting screen 500 of FIG. 5 displayed on the output unit 206 of the client terminal 102 before the first cloud print processing is performed.

FIG. 5 is a diagram that shows an example of the setting screen 500 displayed on the output unit 206 shown in FIG. 2. The setting screen 500 includes a combo box 501, a save destination folder name setting field 502, a username setting field 503, a password setting field 504, a check box 505, an OK button 506, and a cancel button 507. The combo box 501 is a combo box for designating a cloud storage. For example, in the case that the printing system 100 includes a plurality of cloud storages, the combo box 501 allows one cloud storage to be selected from the plurality of cloud storages. A directory for saving a print job in the cloud storage that has been selected by the combo box 501 is inputted into the save destination folder name setting field 502. This directory is saved as storage destination information for the print job. Authentication information for the cloud storage that has been selected by the combo box 501, specifically, a username to be used when connecting to the cloud storage that has been selected by the combo box 501, is inputted into the username setting field 503. The authentication information for the cloud storage that has been selected by the combo box 501, specifically, a password to be used when connecting to the cloud storage that has been selected by the combo box 501, is inputted into the password setting field 504. The check box 505 is a check box for setting whether or not to require input of a username and a password each time when connecting to the cloud storage that has been selected by the combo box 501, without saving the information in the username setting field 503 and the information in the password setting field 504. When the check box 505 is selected, the setting values that have been set by the username setting field 503 and the password setting field 504 are cleared, and input operations in the username setting field 503 and the password setting field 504 are disabled. When the OK button 506 is selected, the setting values that have been set on the setting screen 500 are saved in the HDD 204 of the client terminal 102 as the authentication information for the cloud storage that has been selected by the combo box 501, and the setting screen 500 is closed. When the cancel button 507 is selected, the setting values that have been set on the setting screen 500 are not saved in the HDD 204 of the client terminal 102, and the setting screen 500 is closed.

As shown in FIG. 4A and FIG. 4B, first, in S401 (step 401), the user issues a print instruction of document data that he or she has been editing or viewing by using the application 105 of the client terminal 102.

Next, in S402, the application 105 transmits, to the CPU 201 of the client terminal 102, the document data and a print start request of the document data.

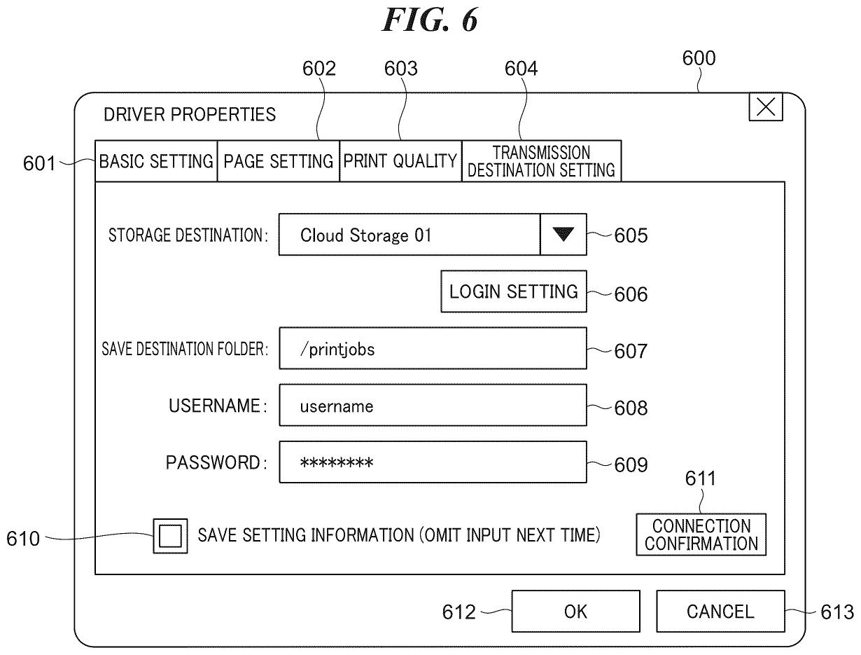

Next, in S403, the client terminal 102 displays a print setting screen shown in FIG. 6 on the output unit 206.

FIG. 6 is a diagram that shows an example of a print setting screen 600 displayed on the output unit 206 shown in FIG. 2. The print setting screen 600 is a screen for performing a print setting of the obtained document data and setting of a save location of a print job. The print setting screen 600 includes tabs 601 to 604, a combo box 605, a login setting button 606, a save destination folder name setting field 607, a username setting field 608, a password setting field 609, a check box 610, and a connection confirmation button 611. In addition, the print setting screen 600 includes an OK button 612 and a cancel button 613.

The tabs 601 to 604 are tab buttons for switching to corresponding setting screens. For example, when the tab 601 is selected, a screen for performing a basic print setting is displayed. When the tab 602 is selected, a screen for performing a print setting for the page is displayed. When the tab 603 is selected, a screen for setting the print quality is displayed. In FIG. 6, as an example, the tab 604 is selected, and a screen for performing the setting of the save location of the print job is displayed.

The combo box 605 is a combo box for designating the save location of the print job. By using the combo box 605, it is possible to designate a cloud storage other than a storage of the cloud print server 107. For example, in the case that the printing system 100 includes a plurality of cloud storages, the combo box 605 allows one cloud storage to be selected from the plurality of cloud storages. It should be noted that in the first embodiment, a configuration, in which for example, only cloud storage(s) that the image forming apparatus 101 is able to access from among the plurality of cloud storages included in the printing system 100 is/are displayed on the combo box 605, may be adopted. In addition, in the case that the settings on the setting screen 500 have been performed in advance, a configuration, in which the setting values that have been set in the items 502 to 505 on the setting screen 500 are automatically set in the items 607 to 610, respectively, may be adopted.

The login setting button 606 is a button for opening the setting screen 500. A directory for saving a print job in the cloud storage that has been selected by the combo box 605 is inputted into the save destination folder name setting field 607. This directory is saved as storage destination information for the print job. A username as authentication information to be used when connecting to the cloud storage that has been selected by the combo box 605 is inputted into the username setting field 608. A password as the authentication information to be used when connecting to the cloud storage that has been selected by the combo box 605 is inputted into the password setting field 609. The check box 610 is a check box for saving the information in the username setting field 608 and the information in the password setting field 609, and for making the input of the next time unnecessary.

The connection confirmation button 611 is a button for confirming whether or not it is possible to connect to the cloud storage that has been selected by the combo box 605. When the OK button 612 is selected, the setting values that have been set on the print setting screen 600 are saved in the RAM 203 of the client terminal 102, and the print setting screen 600 is closed. At this time, in the case that the check box 610 has been selected, the setting values that have been set on the print setting screen 600 are saved in the HDD 204 of the client terminal 102 as the authentication information for the cloud storage that has been selected by the combo box 605, and the print setting screen 600 is closed. When the cancel button 613 is selected, the setting values that have been set on the print setting screen 600 are not saved in the RAM 203 of the client terminal 102, and the print setting screen 600 is closed.

Returning to FIG. 4A and FIG. 4B, in S404, the user inputs the print setting and a transmission destination setting of the document data on the print setting screen 600 displayed on the output unit 206. In the transmission destination setting, on the screen displayed by selecting the tab 604, a cloud storage that becomes the save location of the print job is designated. In the first embodiment, it is assumed that the cloud storage 106 has been designated.

Next, in S405, the user confirms that the setting values that have been inputted into the print setting screen 600 displayed on the output unit 206 are correct, and issues a print job transmission instruction to the client terminal 102 (instructs the client terminal 102 to transmit a print job).

Next, in S406, the client terminal 102 performs a print job generation processing. In the print job generation processing, a print job including the document data and the print setting that has been inputted into the print setting screen 600 is generated.

Next, in S407, the client terminal 102 obtains the authentication information for the cloud storage 106 from the HDD 204. In addition, the client terminal 102 obtains the storage destination information from the HDD 204.

Next, in S408, the client terminal 102 performs a login processing with respect to the cloud storage 106 by using the obtained authentication information. It should be noted that in the case that the authentication information for the cloud storage 106 has not been saved in the HDD 204, in S407, the client terminal 102 displays, on the output unit 206, a dialog box that prompts the user to input a username and a password. Furthermore, the client terminal 102 performs the login processing of S408 by using the username and the password that have been inputted.

In S409, the cloud storage 106 transmits a login processing result notification to the client terminal 102.

The client terminal 102, which has received a login processing result notification indicating the success of the login processing from the cloud storage 106, transmits in S410 the print job, the storage destination information, and a print job save request to the cloud storage 106. It should be noted that in the case that the client terminal 102 has received a login processing result notification indicating the failure of the login processing, the client terminal 102 may display, on the output unit 206, a dialog box that prompts the user to input a username and a password, and perform the login processing again by using the username and the password that have been inputted.

Next, in S411, the cloud storage 106 performs a file save processing that saves the print job in the directory indicated by the storage destination information. Next, in S412, the cloud storage 106 transmits, to the client terminal 102, a save completion notification which indicates that saving of the print job has been completed. It should be noted that in the case that the remaining capacity of the cloud storage 106 is equal to or less than the data amount of the print job that has been transmitted from the client terminal 102 in S410, the cloud storage 106 is not able to store this print job. In this case, in S412, the cloud storage 106 transmits a save failure notification to the client terminal 102. The client terminal 102 that has received the save failure notification may notify the user that saving of the print job has failed, and may return the processing to S407, prompting the user to select another cloud storage.

Next, in S413, the client terminal 102 transmits, to the cloud storage 106, a request for issuing access information used when the image forming apparatus 101 obtains the print job that has been saved in the cloud storage 106, for example, a request for issuing an access token for the print job.

Next, the cloud storage 106 issues an access token with an expiration date, and in S414, transmits this access token to the client terminal 102.

Next, the client terminal 102 generates print job related information. The print job related information includes information indicating the print job, such as the name of the print job transmitted in S410, rather than the entity data of the print job. Furthermore, the print job related information includes the storage destination information transmitted in S410, information indicating the cloud storage 106 that is the transmission destination of the storage destination information, the access token obtained from the cloud storage 106, information about the expiration date of this access token, etc. In other words, the print job related information does not include the entity data of the print job. In S415, the client terminal 102 transmits this print job related information to the cloud print server 107.

Next, in S416, the cloud print server 107 performs a processing for updating a print job list that manages the print jobs that have been saved in the cloud storage 106 (an update processing of the print job list). In this update processing, information about the print job that has been newly saved in the cloud storage 106 in S411 is added to the print job list in which information about the print jobs that have been saved in the cloud storage 106 up until now has been registered. Next, in S417, the cloud print server 107 transmits a print job transmission completion notification to the client terminal 102.

The steps of S401 to S417 are the description of the procedure for saving the print job in the cloud storage 106 and for the cloud print server 107 to register the information about the print job in the print job list.

Next, the flow, in which the image forming apparatus 101 obtains the print job related information from the cloud print server 107, obtains a print job corresponding to the print job related information from the cloud storage 106, and executes a print processing, will be described.

In S418, the user instructs any image forming apparatus that is able to access the cloud print server 107 to execute cloud print. In the first embodiment, as an example, it is assumed that the user has instructed the image forming apparatus 101 to execute cloud print by operating the operation unit 305 of the image forming apparatus 101.

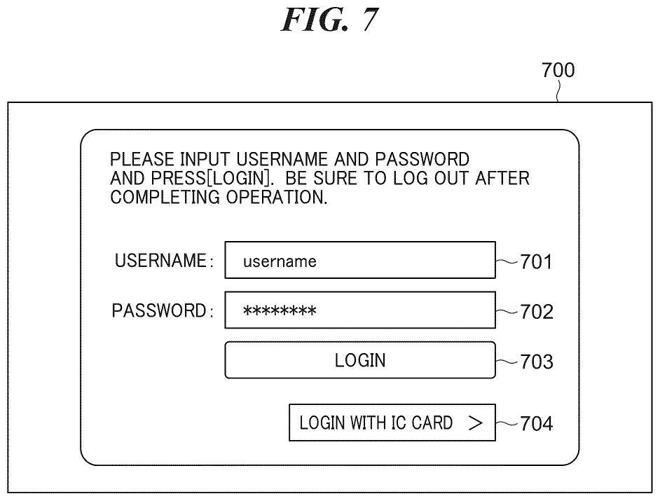

Next, in S419, the image forming apparatus 101 causes the operation unit 305 to display a cloud print authentication screen 700 of FIG. 7 which prompts the user to input authentication information required to access the cloud print server 107.

FIG. 7 is a diagram that shows an example of the cloud print authentication screen 700 displayed on the operation unit 305 shown in FIG. 3. The cloud print authentication screen 700 includes a username input field 701, a password input field 702, a login button 703, and a “login with IC card” button 704.

A username as authentication information to be used when connecting to the cloud print server 107 is inputted into the username input field 701. A password as the authentication information to be used when connecting to the cloud print server 107 is inputted into the password input field 702. When the login button 703 is selected, the image forming apparatus 101 transmits the authentication information (the username and the password) inputted by the cloud print authentication screen 700 to the cloud print server 107, and closes the cloud print authentication screen 700. The cloud print server 107 executes a login processing by using the received authentication information.

The “log in with IC card” button 704 is displayed in the case that the image forming apparatus 101 includes an IC card reader or the like in the input unit 306. When the user selects the “log in with IC card” button 704 and touches the input unit 306 with an IC card, the image forming apparatus 101 reads authentication information from the IC card. The image forming apparatus 101 transmits this authentication information to the cloud print server 107, and closes the cloud print authentication screen 700. The cloud print server 107 executes a login processing by using the received authentication information.

Returning to FIG. 4A and FIG. 4B, in S420, the user inputs the authentication information for the cloud print server 107 into the image forming apparatus 101. In the first embodiment, the authentication information for the cloud print server 107 is inputted into the image forming apparatus 101 when the user directly inputs the authentication information into the operation unit 305 or when the user touches the input unit 306 with the IC card. Next, in S421, the image forming apparatus 101 transmits the inputted authentication information to the cloud print server 107.

Next, in S422, the cloud print server 107 performs an authentication processing by using the obtained authentication information. In S423, the cloud print server 107 that has been successfully authenticated transmits, to the image forming apparatus 101, an authentication completion notification and print job list information that is obtained from the print job list. The print job list information is list information of the print jobs that have been saved in the cloud storage 106.

Next, in S424, the image forming apparatus 101 causes the operation unit 305 to display a print job list screen (not shown) by using the received print job list information. Next, in S425, the user selects a print job to be printed on the print job list screen. Next, in S426, the image forming apparatus 101 reflects on the print job list screen that the print job has been selected by the user (the print job is in a selected state).

Next, in S427, the user issues a print execution instruction of the selected print job to the image forming apparatus 101. Next, in S428, the image forming apparatus 101 transmits, to the cloud print server 107, a request for obtaining print job related information corresponding to the print job that has been selected by the user in S425 (an obtaining request). Next, in S429, the cloud print server 107 transmits, to the image forming apparatus 101, print job related information corresponding to the obtaining request that has been received from the image forming apparatus 101.

Next, in S430, the image forming apparatus 101 transmits, to the cloud storage 106, the access token included in the received print job related information and a request for obtaining a print job corresponding to this print job related information (a print job obtaining request). It should be noted that in S430, the transmission destination of the access token and the print job obtaining request is identified as the cloud storage 106 based on the storage destination information and the like that are included in this print job related information.

Next, in S431, the cloud storage 106 transmits, to the image forming apparatus 101, a print job corresponding to the received print job obtaining request. Next, in S432, the image forming apparatus 101 executes a print processing of the received print job, and ends the first cloud print processing.

As described above, in the above-described embodiment, unlike the conventional method of saving a print job in the storage of the cloud print server 107, a print job is saved in the cloud storage 106 that is designated by the user. As a result, in the cloud print service, it is possible to save a print job in the cloud storage other than the storage of the cloud print server 107. As a result, a user who feels that there is a risk in saving a print job in the storage of the cloud print server 107 from the viewpoint of security or the like is able to feel at ease by being allowed to use the cloud storage 106 which he or she is familiar with. In addition, with the above-described configuration, the cloud print server 107 does not save print jobs with a relatively large amount of data, so the cloud print server 107 does not need to be equipped with a large-capacity storage. In addition, since the cloud print server 107 does not transmit or receive the entity data of a print job, which has a relatively large amount of data, the communication load of the cloud print server 107 is reduced. As a result, it is also possible to reduce the management costs of the cloud print server 107 at the printer manufacturer.

In addition, in the above-described embodiment, the save location of the print job is a storage that has been selected by the user from among the plurality of cloud storages. As a result, in the configuration in which the user uses the plurality of cloud storages, the user is able to save a print job in the cloud storage of his or her choice.

Next, a printing system according to a second embodiment of the present invention will be described.

The second embodiment is basically the same as the first embodiment described above in terms of configuration and operation, but differs from the first embodiment described above in that the printing system does not include a cloud print server. Therefore, descriptions of overlapping configurations and operations will be omitted, and only different configurations and operations will be described below.

Here, as a cloud print system that does not use a cloud print server, a configuration, in which an image forming apparatus directly obtains document data that has been stored in a cloud storage being used by a user of OneDrive, Google Drive, or the like, has been known. In such a configuration, since there is no need to sign a contract for a cloud print service that uses a cloud print server, it is possible to reduce the cost of using cloud print. On the other hand, in such a configuration, since the cloud storage saves document data before it is converted into a print job, detailed print settings that are capable of being set by the printer driver or the like, and settings of functions unique to the image forming apparatus cannot be made. Furthermore, there is a problem that only document data in a format that is capable of being directly processed by the image forming apparatus can be printed.

In order to deal with this issue, in the second embodiment, the print job converted from the document data is saved in the cloud storage 106 designated by the user.

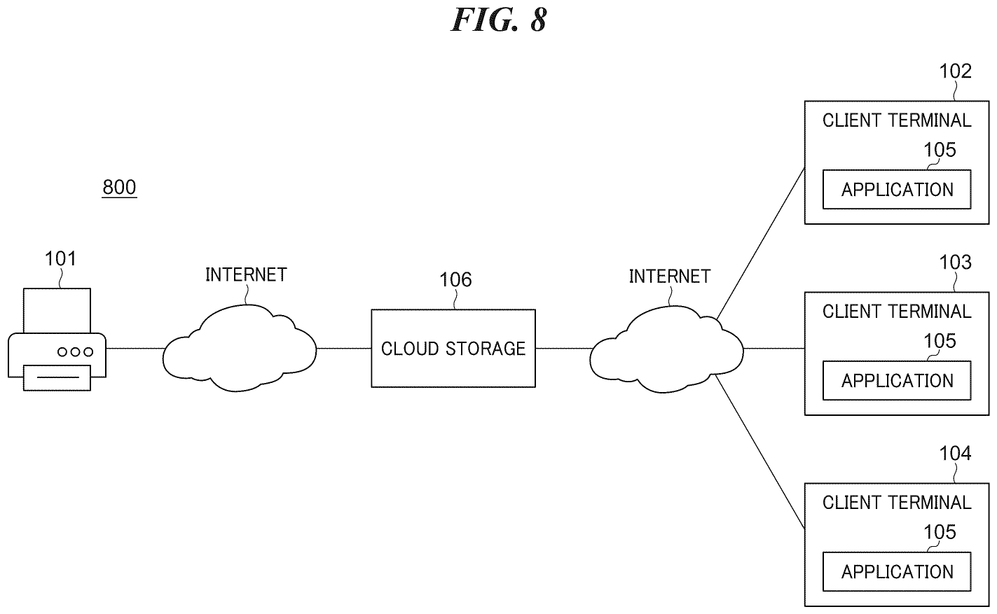

FIG. 8 is a configuration diagram that shows an example of a printing system 800 according to the second embodiment. The printing system 800 is different from the above-described printing system 100 in that the printing system 800 does not include the cloud print server 107. Specifically, the printing system 800 includes the image forming apparatus 101, the cloud storage 106, and one or more client terminals. It should be noted that in the second embodiment, as an example, a configuration in which the printing system 800 includes three client terminals 102 to 104 will be described. In addition, in the second embodiment, a configuration in which the printing system 800 includes one cloud storage 106 will be described as an example, but the present invention is not limited to this configuration. For example, the printing system 800 may be configured to include a plurality of cloud storages. The image forming apparatus 101, the cloud print server 107, and the client terminals 102 to 104 are each communicably connected to each other via the Internet. In the printing system 800, the client terminal 102 transmits a print job to the cloud storage 106, and the image forming apparatus 101 obtains the print job from the cloud storage 106 and performs a print processing.

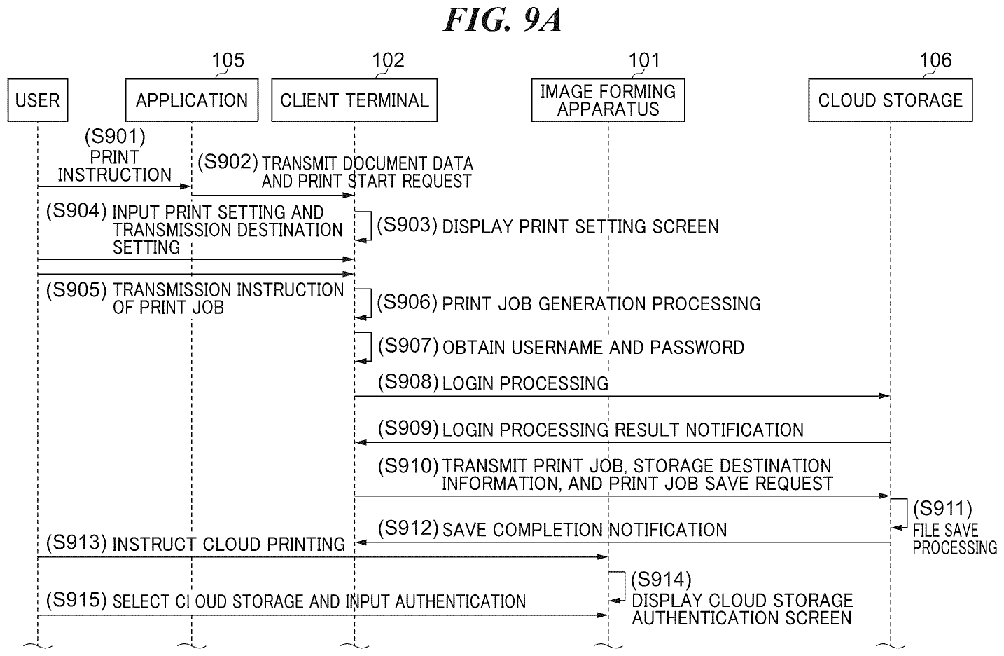

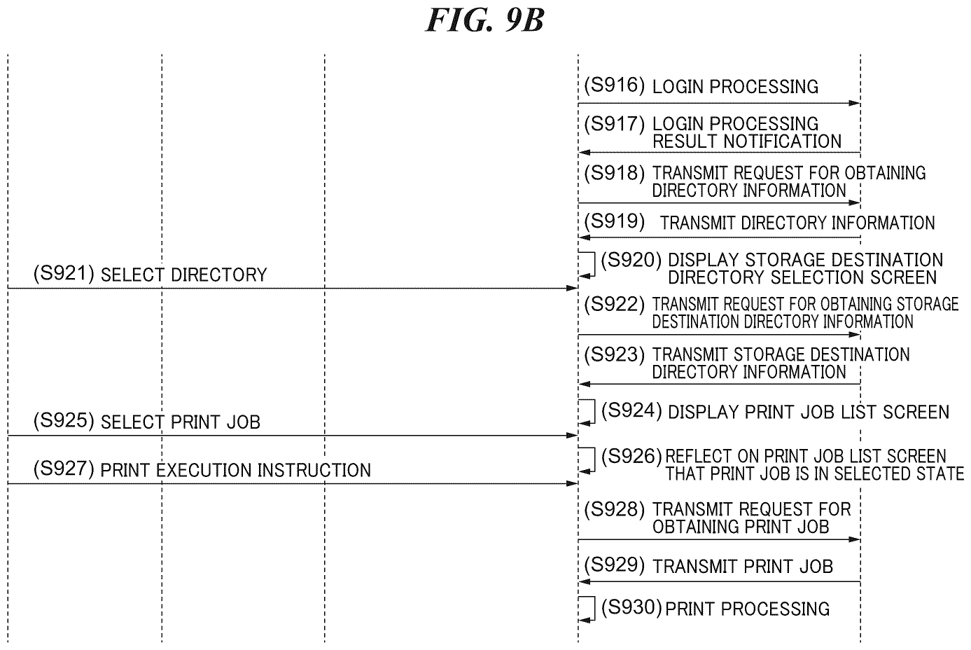

FIG. 9A and FIG. 9B are sequence diagrams that show the steps of a second cloud print processing executed by the printing system 800 shown in FIG. 8. In FIG. 9A and FIG. 9B, as an example, a configuration in which the second cloud print processing is performed by the client terminal 102, the cloud storage 106, and the image forming apparatus 101 will be described. In FIG. 9A and FIG. 9B, the processing by the client terminal 102 is realized by the CPU 201 loading a program stored in the ROM 202 or the like into the RAM 203 and executing the program. The processing by the image forming apparatus 101 is realized by the CPU 301 loading a program stored in the ROM 302 or the like into the RAM 303 and executing the program. It should be noted that the second cloud print processing is a processing similar to the first cloud print processing described above, and the following will particularly describe the differences from the first cloud print processing described above. In the second cloud print processing, similar to the first cloud print processing, it is assumed that the settings on the setting screen 500 described above have been performed in advance.

As shown in FIG. 9A and FIG. 9B, first, the processes of S901 to S912, which are the same as the above-described processes of S401 to S412, are performed. The steps of S901 to S912 are the description of the procedure for saving the print job in the cloud storage 106 from the client terminal 102.

Next, the flow, in which the image forming apparatus 101 obtains a print job from the cloud storage 106 and executes a print processing, will be described.

In S913, the user instructs any image forming apparatus that is able to access the cloud storage 106 to execute cloud print. In the second embodiment, as an example, it is assumed that the user has instructed the image forming apparatus 101 to execute cloud print by operating the operation unit 305 of the image forming apparatus 101.

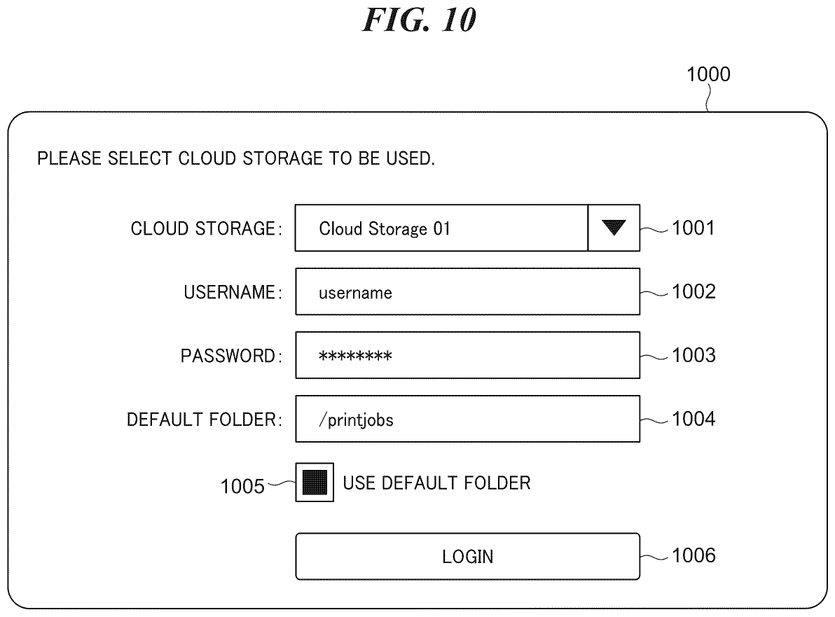

Next, in S914, the image forming apparatus 101 causes the operation unit 305 to display a cloud storage authentication screen 1000 of FIG. 10 which prompts the user to input authentication information required to access the cloud storage 106.

FIG. 10 is a diagram that shows an example of the cloud storage authentication screen 1000 displayed on the operation unit 305 shown in FIG. 3.

The cloud storage authentication screen 1000 includes a combo box 1001, a username input field 1002, a password input field 1003, a default folder name setting field 1004, a check box 1005, and a login button 1006.

The combo box 1001 is a combo box for designating a cloud storage to be used. By using the combo box 1001, it is possible to designate a cloud storage other than the storage of the cloud print server 107. For example, in the case that the printing system 800 includes a plurality of cloud storages, the combo box 1001 allows one cloud storage to be selected from the plurality of cloud storages. It should be noted that a configuration, in which for example, only cloud storage(s) that the image forming apparatus 101 is able to access from among the plurality of cloud storages included in the printing system 800 is/are displayed on the combo box 1001, may be adopted. A username as authentication information to be used when connecting to the cloud storage that has been selected by the combo box 1001 is inputted into the username input field 1002. A password as the authentication information to be used when connecting to the cloud storage that has been selected by the combo box 1001 is inputted into the password input field 1003. A directory for saving a print job in the cloud storage that has been selected by the combo box 1001 is inputted into the default folder name setting field 1004. This directory is designated as a default directory, and is saved as storage destination information for the print job.

The check box 1005 is a check box for selecting whether or not to use the default directory that has been set by the default folder name setting field 1004.

In the case that the check box 1005 has been selected, when executing cloud printing, the image forming apparatus 101 obtains the print job from the default directory. On the other hand, in the case that the check box 1005 has not been selected, the default folder name setting field 1004 is deleted, and when executing cloud printing, the user needs to designate the directory in which the print job has been saved. The login button 1006 is a button for issuing an authentication instruction of the selected cloud storage.

Returning to FIG. 9A and FIG. 9B, in S915, by means of the cloud storage authentication screen 1000, the user selects a cloud storage to be used and inputs authentication information to be used when connecting to the selected cloud storage. In the following, as an example, it is assumed that the user has selected the cloud storage 106 as the cloud storage to be used. In addition, the user selects the login button 1006 to issue an authentication instruction of the cloud storage 106. When the login button 1006 is selected, the setting values that have been set on the cloud storage authentication screen 1000 are transmitted to the cloud storage 106, and the cloud storage authentication screen 1000 is closed.

It should be noted that in the second embodiment, the user needs to select the cloud storage (perform a cloud storage selection operation) on both the client terminal 102 (for example, in S904) and the image forming apparatus 101 (for example, in S915). Therefore, a configuration may be adopted in which it is possible to set in advance so that the same cloud storage is displayed in both the combo box 605 of the print setting screen 600 and the combo box 1001 of the cloud storage authentication screen 1000 in a state where the same cloud storage is designated as the initial value. With such a configuration, it is possible to reduce the labor and time required for performing the cloud storage selection operation.

Next, in S916, the image forming apparatus 101 performs a login processing to the cloud storage 106 by using the authentication information that has been inputted by means of the cloud storage authentication screen 1000.

Next, in S917, the cloud storage 106 transmits a login processing result notification to the client terminal 102.

The image forming apparatus 101, which has received a login processing result notification indicating the success of the login processing from the cloud storage 106, transmits to the cloud storage 106 in S918 a request for obtaining directory information indicating the directory structure of the cloud storage 106 (a directory information obtaining request). It should be noted that in the case that the image forming apparatus 101 has received a login processing result notification indicating the failure of the login processing, the image forming apparatus 101 may return to S914 and request the user to input the authentication information again.

Upon receiving the directory information obtaining request, the cloud storage 106 transmits in S919 the directory information of the cloud storage 106 to the image forming apparatus 101.

Next, in S920, the image forming apparatus 101 causes the operation unit 305 to display a storage destination directory selection screen (not shown) by using the obtained directory information. The storage destination directory selection screen is a screen that prompts the user to select a directory in which a print job to be printed has been saved.

Next, in S921, the user selects a directory in which a print job to be printed has been saved by means of the storage destination directory selection screen.

Next, in S922, the image forming apparatus 101 transmits a request for obtaining storage destination directory information. The storage destination directory information is list information of print jobs that have been stored in the directory selected by the user in S921.

Next, in S923, the cloud storage 106 transmits storage destination directory information to the image forming apparatus 101. It should be noted that in the case that the check box 1005 has been selected on the cloud storage authentication screen 1000 in S915, after the process of S919 is performed, the processes of S920 to S923 may not be performed and the process of S924 may be performed.

In S924, the image forming apparatus 101 displays a print job list screen by using the storage destination directory information. After that, the processes of S925 to S927, which are the same as the above-described processes of S425 to S427, are performed.

Next, in S928, the image forming apparatus 101 transmits, to the cloud storage 106, a request for obtaining the print job that has been selected by the user on the print job list screen (an obtaining request). Next, in S929, the cloud storage 106 transmits, to the image forming apparatus 101, a print job corresponding to the received obtaining request. Next, in S930, the image forming apparatus 101 executes a print processing of the received print job. Thereafter, the second cloud print processing ends.

In the second embodiment, the client terminal 102 transmits the print job including the document data and the print setting to the cloud storage 106, and the image forming apparatus 101 obtains the print job from the cloud storage 106 and executes the print processing. That is, the cloud print server 107 is not used. As a result, it is possible to realize cloud print that performs the print processing of the print job including the print setting set on the print setting screen 600 while suppressing the usage cost of the cloud print server 107.

It should be noted that in the second embodiment, the image forming apparatus 101 may be registered in advance in the client terminal 102 so that a print job optimal for the image forming apparatus 101 is generated.

In addition, in the above-described embodiment, the configuration in which the print job is stored in the cloud storage 106 has been described, but the present invention is not limited to this configuration. For example, the print job may be stored in a storage of the client terminal 102 such as the HDD 204, or the print job may be stored in a storage or the like of the client terminals 103 and 104 other than the client terminal 102.

Next, a printing system according to a third embodiment of the present invention will be described.

The third embodiment is basically the same as the first embodiment described above in terms of configuration and operation, but differs from the first embodiment described above in that an account for the cloud print server 107 is linked to an account for the cloud storage 106. Therefore, descriptions of overlapping configurations and operations will be omitted, and only different configurations and operations will be described below.

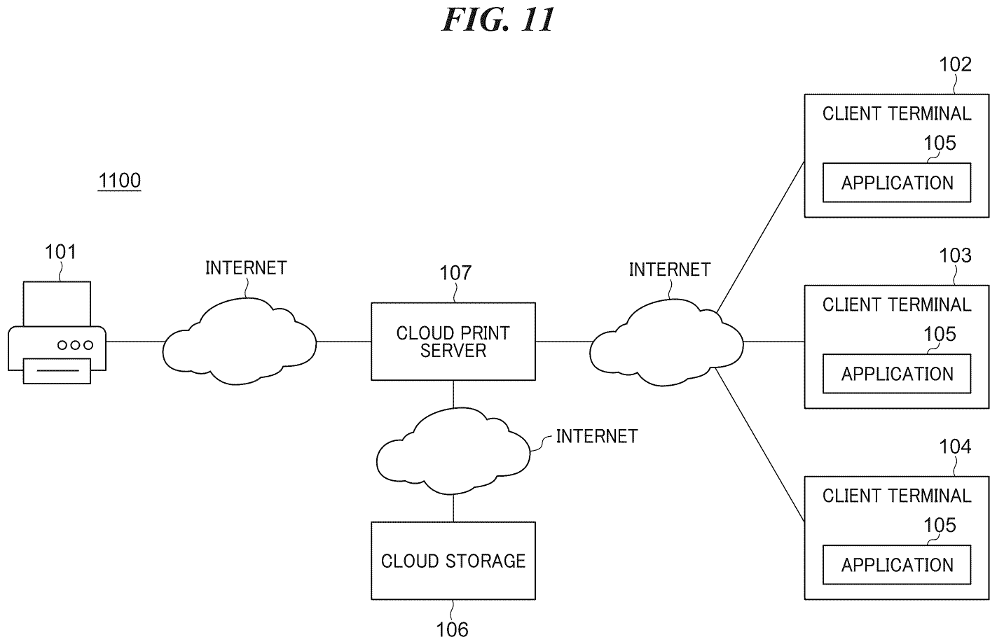

FIG. 11 is a configuration diagram that shows an example of a printing system 1100 according to the third embodiment. The printing system 1100 is different from the above-described printing system 100 shown in FIG. 1 in that the cloud storage 106 is connected to the cloud print server 107 via the Internet. The printing system 1100 includes the image forming apparatus 101, the cloud storage 106, the cloud print server 107, and one or more client terminals. It should be noted that in the third embodiment, as an example, a configuration in which the printing system 1100 includes three client terminals 102 to 104 will be described. In addition, in the third embodiment, a configuration in which the printing system 1100 includes one cloud storage 106 will be described as an example, but the present invention is not limited to this configuration. For example, the printing system 1100 may be configured to include a plurality of cloud storages. The image forming apparatus 101, the cloud print server 107, and the client terminals 102 to 104 are each communicably connected to each other via the Internet.

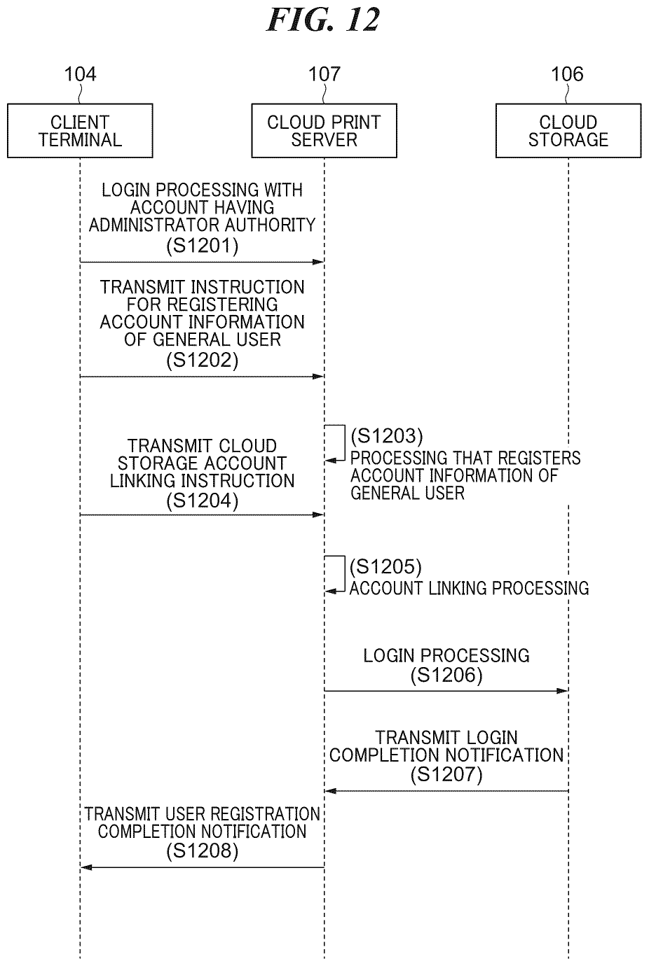

FIG. 12 is a sequence diagram that shows an example of an account linking registration processing executed by the printing system 1100 shown in FIG. 11.

The account linking registration processing is a processing in which an administrator having administrator authority of the cloud print server 107 registers an account of a general user of the cloud print server 107 and an account of the general user of the cloud storage 106 in association with each other (in linking to each other). It should be noted that the general user of the cloud print server 107 is a user who does not have the administrator authority of the cloud print server 107. The account of the general user of the cloud print server 107 is an account for the general user to use the cloud print server 107. The account of the general user of the cloud storage 106 is an account for the general user to use the cloud storage 106.

The account linking registration processing is performed by the client terminal 104 that is operated by the administrator, the cloud storage 106, and the cloud print server 107. In the account linking registration processing, the processing by the client terminal 104 is realized by a CPU of the client terminal 104 loading a program stored in a ROM or the like of the client terminal 104 into a RAM of the client terminal 104 and executing the program. The processing by the cloud print server 107 is realized by the CPU of the cloud print server 107 loading a program stored in the ROM or the like of the cloud print server 107 into the RAM of the cloud print server 107 and executing the program.

As shown in FIG. 12, in S1201, the client terminal 104 executes a login processing to the cloud print server 107 with an account having the administrator authority of the cloud print server 107.

In S1202, the client terminal 104 that has logged in with the account having the administrator authority of the cloud print server 107 transmits, to the cloud print server 107, an instruction for registering account information of a general user of the cloud print server 107 (a registration instruction). This registration instruction includes the account information of the general user to be registered, for example, includes an account name of this general user and authentication information thereof.

Next, in S1203, the cloud print server 107 performs a registration processing of the account information of the general user (a processing that registers the account information of the general user) in accordance with the accepted registration instruction. This allows the cloud print server 107 to be used with the registered account information. It should be noted that in the case that the account information of the general user has already been registered, the processes of S1202 and S1203 may be omitted.

Next, in S1204, the client terminal 104 transmits a cloud storage account linking instruction to the cloud print server 107. The cloud storage account linking instruction includes the account information of the general user, and storage destination information indicating a directory of the cloud storage 106 in which a print job of the general user is to be saved.

Next, in S1205, the cloud print server 107 executes an account linking processing. In the account linking processing, the account of the general user of the cloud print server 107 is linked to the account of the general user of the cloud storage 106 indicated by the storage destination information. In addition, the storage destination information is saved in an HDD of the cloud print server 107 in association with these accounts (in linking to these accounts).

Next, in S1206, the cloud print server 107 executes a login processing to the cloud storage 106 by using the account of the cloud storage 106 that has been linked to the account of the general user of the cloud print server 107.

In S1207, the cloud storage 106 that has been successfully logged in transmits a login completion notification to the cloud print server 107.

Next, in S1208, the cloud print server 107 transmits, to the client terminal 104, a user registration completion notification indicating that the account linking registration processing has been successful. Thereafter, the account linking registration processing ends.

It should be noted that the account of the general user of the cloud print server 107 may be linked to a plurality of accounts of the cloud storage 106. In addition, the priority order of the cloud storage to be used, and the job save capacity limit for the storage destination of each print job may be set.

In addition, when the general user logs in to the cloud print server 107 for the first time, the general user may be able to reset the authentication information and the storage destination of the print job in the cloud storage and the cloud print server 107 to which the account of the general user has been linked.

In addition, an expiration date may be set for each type of authentication information, and the general user may be notified of the expiration date of the authentication information by being prompted to reset the authentication information a certain period of time (for example, ten days) before the expiration date.

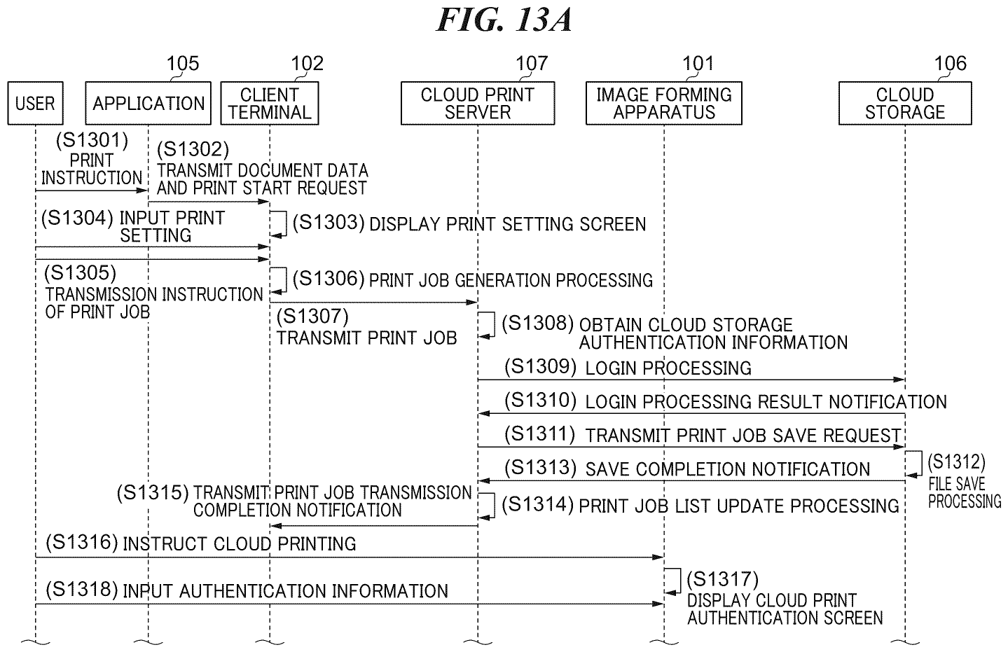

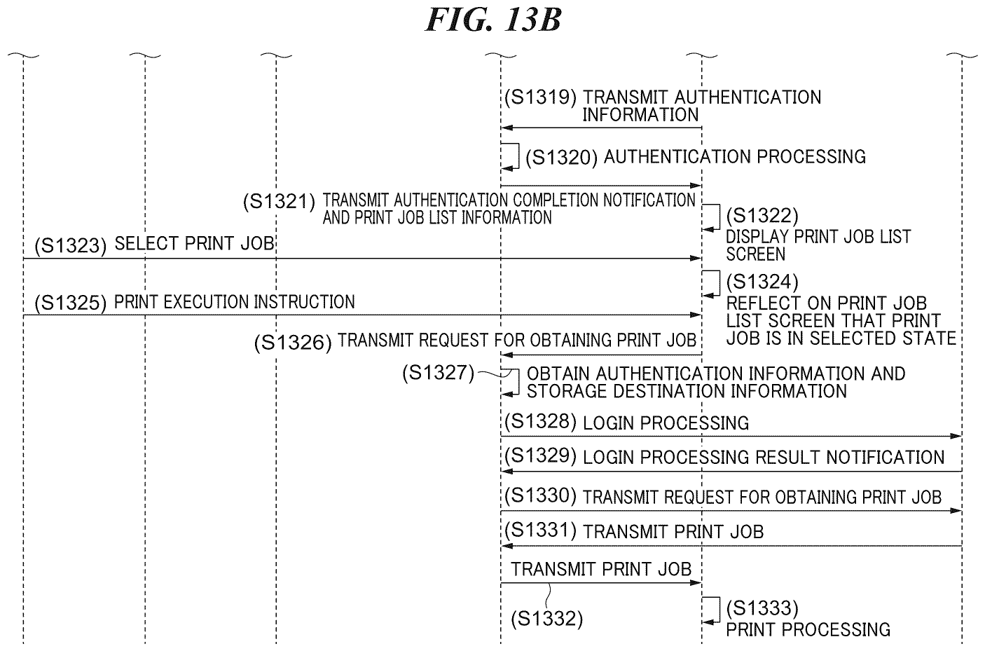

FIG. 13A and FIG. 13B are sequence diagrams that show the steps of a third cloud print processing executed by the printing system 1100 shown in FIG. 11. In FIG. 13A and FIG. 13B, as an example, a configuration in which the third cloud print processing is performed by the client terminal 102, the cloud print server 107, the cloud storage 106, and the image forming apparatus 101 will be described. It should be noted that the client terminal 102 is a terminal operated by a general user (hereinafter, simply referred to as “a user”). In FIG. 13A and FIG. 13B, the processing by the client terminal 102 is realized by the CPU 201 loading a program stored in the ROM 202 or the like into the RAM 203 and executing the program. The processing by the cloud print server 107 is realized by the CPU of the cloud print server 107 loading a program stored in the ROM or the like of the cloud print server 107 into the RAM of the cloud print server 107 and executing the program. The processing by the image forming apparatus 101 is realized by the CPU 301 loading a program stored in the ROM 302 or the like into the RAM 303 and executing the program. It should be noted that the third cloud print processing is a processing similar to the first cloud print processing described above, and the following will particularly describe the differences from the first cloud print processing described above. In FIG. 13A and FIG. 13B, it is assumed that the account linking registration processing shown in FIG. 12 described above has been executed, and an account of a user of the cloud print server 107 and an account of the user of the cloud storage 106 have been linked to each other and registered. In addition, it is assumed that in the client terminal 102, the authentication information for the cloud storage 106 and the authentication information for the cloud print server 107 have been outputted from the application 105 to the print framework.

As shown in FIG. 13A and FIG. 13B, first, the processes of S1301 to S1302, which are the same as the above-described processes of S401 to S402, are performed.

Next, in S1303, the client terminal 102 causes the output unit 206 to display a print setting screen. This print setting screen differs from the print setting screen 600 shown in FIG. 6 described above in that this print setting screen does not include the tab 604 for switching to a screen for performing the setting of the cloud storage. Therefore, in the printing system 1100, the user does not need to select the cloud storage on the print setting screen (perform the cloud storage selection operation on the print setting screen).

Next, in S1304, the user inputs a print setting of the document data on the print setting screen displayed on the output unit 206. Next, in S1305, the user confirms that the setting values that have been inputted into the print setting screen displayed on the output unit 206 are correct, and issues a print job transmission instruction to the client terminal 102 (instructs the client terminal 102 to transmit a print job).

Next, in S1306, the client terminal 102 performs a print job generation processing. In the print job generation processing, a print job including the document data and the print setting that has been inputted into the print setting screen is generated. Next, in S1307, the client terminal 102 transmits the print job to the cloud print server 107.

Next, in S1308, the cloud print server 107 obtains authentication information for the account of the user of the cloud storage 106, which has been linked to the account of the user of the cloud print server 107, and storage destination information for the print job.

Next, in S1309, the cloud print server 107 executes a login processing to the cloud storage 106 by using the authentication information obtained in S1308.

Next, in S1310, the cloud storage 106 transmits a login processing result notification to the cloud print server 107. Here, it is assumed that a login processing result notification indicating the success of the login processing has been transmitted.

Next, in S1311, the cloud print server 107 transmits, to the cloud storage 106, a print job save request that includes the print job and the storage destination information for the print job.

Next, in S1312, the cloud storage 106 performs a file save processing. In the file save processing, the obtained print job is saved in the directory indicated by the obtained storage destination information. Next, in S1313, the cloud storage 106 transmits, to the cloud print server 107, a save completion notification which indicates that saving of the print job has been completed. It should be noted that in the case that the cloud print server 107 receives a save failure notification and a plurality of cloud storages have been set, the cloud print server 107 may perform the following processes. Specifically, the cloud print server 107 obtains authentication information for the cloud storage with the next priority order setting and the storage destination information, and returns to S1309 to perform a login processing to the cloud storage with the next priority order setting. After the process of S1313 is completed, the processes of S1314 to S1315, which are the same as the above-described processes of S416 to S417, are performed. The steps of S1301 to S1315 are the description of the procedure for saving the print job in the cloud storage 106.

Next, the flow, in which the image forming apparatus 101 obtains print job related information from the cloud print server 107, obtains a print job corresponding to the print job related information from the cloud storage 106, and executes a print processing, will be described.

First, the processes of S1316 to S1325, which are the same as the above-described processes of S418 to S427, are performed.

Next, in S1326, the image forming apparatus 101 transmits, to the cloud print server 107, a request for obtaining the print job that has been selected by the user in S1323 (an obtaining request).

Next, in S1327, the cloud print server 107 obtains the authentication information for the cloud storage 106 that has saved the print job designated by the obtaining request, and the storage destination information.

Next, in S1328, the cloud print server 107 executes a login processing to the cloud storage 106 by using the authentication information obtained in S1327.

Next, in S1329, the cloud storage 106 transmits a login processing result notification to the cloud print server 107. Here, it is assumed that a login processing result notification indicating the success of the login processing has been transmitted.

Next, in S1330, the cloud print server 107 transmits a request for obtaining the print job (an obtaining request) by using the storage destination information obtained in S1327.

Next, in S1331, the cloud storage 106 transmits a print job corresponding to this obtaining request to the cloud print server 107.

In S1332, the cloud print server 107 transmits the print job that has been received from the cloud storage 106 to the image forming apparatus 101.

In S1333, the image forming apparatus 101 executes a print processing of the print job that has been received from the cloud print server 107. Thereafter, the third cloud print processing ends.

In the above-described third embodiment, the save location of the print job is selected by the cloud print server 107. As a result, it is possible to reduce the user's labor and time in selecting the save location of the print job.

In addition, in the above-described third embodiment, a first account for a user to use the cloud print server 107 has been linked to (has been associated with) a second account for the user to use the cloud storage 106. The cloud print server 107 selects a cloud storage corresponding to the second account that has been linked to the first account of the user. As a result, by simply logging in to the cloud print server 107, the user is able to set the cloud storage corresponding to the second account that has been linked to the first account of the user as the save location of the print job.

In addition, in the above-described embodiment, when logging in to the cloud print server 107 or the cloud storage 106, a one-time password or the like may be set to improve security.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium.

The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-029949, filed on Feb. 29, 2024, which is hereby incorporated by reference herein in its entirety.

What is claimed is:

1. A printing system that provides a cloud print service, the printing system comprising:
at least one processor; and
a memory coupled to the processor storing instructions that, when executed by the processor, cause the processor to perform
causing an information processing apparatus, which has received a print job transmission instruction from a user, to generate a print job and transmit the print job to a save location that has been set; and
causing an image forming apparatus, which has received a print execution instruction from the user, to obtain the print job that has been saved in the save location and execute a print processing of the obtained print job, and
wherein the save location is a cloud storage other than a storage of a cloud print server managed by a manufacturer of the image forming apparatus.

2. The printing system according to claim 1, wherein
the save location is a cloud storage that has been selected from a plurality of cloud storages.

3. The printing system according to claim 2, further comprising:
the cloud print server, and
wherein the save location is a cloud storage that has been selected by the cloud print server.

4. The printing system according to claim 3, wherein
the processor is caused to further perform linking a first account for the user to use the cloud print server to a second account for the user to use the cloud storage, and
the cloud print server selects a cloud storage corresponding to the second account that has been linked to the first account of the user.

5. The printing system according to claim 1, wherein
the cloud print service is realized without using the cloud print server.

6. A control method for a printing system that provides a cloud print service, the control method comprising:
a step of causing an information processing apparatus, which has received a print job transmission instruction from a user, to generate a print job and transmit the print job to a save location that has been set; and
a step of causing an image forming apparatus, which has received a print execution instruction from the user, to obtain the print job that has been saved in the save location and execute a print processing of the obtained print job, and
wherein the save location is a cloud storage other than a storage of a cloud print server managed by a manufacturer of the image forming apparatus.

7. An information processing apparatus that causes an image forming apparatus, which supports a cloud print service, to execute a print processing, the information processing apparatus comprising:
at least one processor; and
a memory coupled to the processor storing instructions that, when executed by the processor, cause the processor to perform
receiving an instruction from a user; and
a control of generating a print job in accordance with the instruction and transmitting the print job to a save location that has been set, and
wherein the image forming apparatus obtains the print job that has been saved in the save location in accordance with a print execution instruction received from the user, and executes a print processing of the obtained print job, and
the save location is a cloud storage other than a storage of a cloud print server managed by a manufacturer of the image forming apparatus.

8. A control method for an information processing apparatus that causes an image forming apparatus, which supports a cloud print service, to execute a print processing, the control method comprising:
a step of receiving an instruction from a user; and
a step of transmitting a print job to a save location that has been set in accordance with the instruction, and
wherein the image forming apparatus obtains the print job that has been saved in the save location in accordance with a print execution instruction received from the user, and executes a print processing of the obtained print job, and
the save location is a cloud storage other than a storage of a cloud print server managed by a manufacturer of the image forming apparatus.

9. A non-transitory computer-readable storage medium storing a program for causing a computer to execute a control method for an information processing apparatus that causes an image forming apparatus, which supports a cloud print service, to execute a print processing,
the control method comprising:
a step of receiving an instruction from a user; and
a step of transmitting a print job to a save location that has been set in accordance with the instruction, and
wherein the image forming apparatus obtains the print job that has been saved in the save location in accordance with a print execution instruction received from the user, and executes a print processing of the obtained print job, and
the save location is a cloud storage other than a storage of a cloud print server managed by a manufacturer of the image forming apparatus.
